(19) United States
(12) Patent Application Publication
(10) Pub. No.: US 2026/0284454 A1
(43) Pub. Date: Sep. 24, 2026

(54) WATERING UNIT, WATERING SYSTEM AND WATERING METHOD

(71) Applicant: Fire and Rescue Innovation Finland FRIF Oy, Suonenjoki (FI)

(72) Inventor: Marko Hassinen, Suonenjoki (FI)

(21) Appl. No.: 19/570,659

(22) Filed: Mar. 18, 2026

(30) Foreign Application Priority Data
Mar. 19, 2025 (EP) 25164831
May 13, 2025 (EP) 25176230

(51) Int. Cl. A62C 31/05; A62C 3/02; A62C 27/00; A62C 33/04

(52) U.S. Cl. CPC A62C 31/05; A62C 3/0292; A62C 27/00; A62C 33/04

(57) ABSTRACT

A watering unit, a watering system and a watering method includes a water container (110) beneath a hose compartment (100) and a plurality of movable arms (160) above it. The arms (160) are designed in a closed position to hold watering devices (200) and release them in an open position. The watering devices (200) are connected to one another with hoses (150) folded in the hose compartment. The watering system is designed to lay a line of watering devices connected with hoses on a terrain to be watered.

### FIELD OF THE INVENTION

The invention relates to watering systems and watering methods for controlling wildfires and ground fires.

### PRIOR ART

Extreme weather conditions are occurring more frequently than before. Prolonged periods of abnormally dry weather increase the risk of wildfires and a wildfire during a severe drought often causes widespread and devastating damages. Once a wildfire has had the time to spread spontaneously, it is next to impossible to extinguish. Such a wildfire can at best be controlled to prevent it from spreading into urban areas.

One way of combating wildfires is to quickly drive a water-filled truck to where the fire erupted and put out the fire with a water cannon. The problem is that the amount of water in the truck is limited and a refill of the truck is not an option due to rapid spread of the fire.

Another way is to water the ground on a wide enough band to prevent fire from spreading across the watered area. The watered band has to be hundreds of meters or thousands of meters long to be effective and it has to be put in place quickly. A set of sprinklers with overlapping spraying areas can create a continuous, watered band on the ground, but there are some difficulties. Firstly, the watered band on the ground must be continuous without any dry strips running across the band. If there is a dry route across the band, the fire will spread across the band. The spraying area of the sprinklers may turn out to be considerably smaller in practice than in theory. For example, a single sprinkler in a suboptimal position may leave a dry route through the otherwise watered band. A single sprinkler partially covered by shrubs or undergrowth in general may have the same effect. Secondly, the sprinklers have to be set-up quickly as time is of the utmost importance when fighting against fires. There is not enough time to build any fixed structures to raise or support the sprinklers as the spreading wildfire may change its course suddenly.

### BRIEF DESCRIPTION OF THE INVENTION

An object of the invention is to develop a watering unit, a watering system and/or a watering method which solves or at least alleviates the afore-mentioned problems. The object of the invention is achieved with a watering unit of claim 1, with a watering system of claim 5 and/or with a method of claim 9. Preferred embodiments of the invention are presented in the dependent claims.

### BRIEF DESCRIPTION OF FIGURES

The invention is now described in more detail in view of preferred embodiments by referring to figures in which:

FIG. 1 illustrates an embodiment of a watering system installed on a trailer;

FIG. 2 shows an embodiment of a hose compartment of a watering unit having arms in a closed position;

FIG. 2a is a detail of FIG. 2 showing an embodiment of a hose clamp in a closed position;

FIG. 3 shows an embodiment of a hose compartment of a watering unit having arms on one side in an open position;

FIG. 3a is a detail of FIG. 3 showing an embodiment of a hose clamp in an open position;

FIG. 4 illustrates an embodiment of a self-erecting watering device having its support legs in an open position;

FIG. 5 shows the embodiment of FIG. 1 seen from a different viewing angle;

FIG. 6 illustrates an embodiment of a self-erecting watering device having its support legs in a closed position;

FIG. 7 shows the embodiment of FIG. 3 seen from a different viewing angle;

FIG. 8 shows an embodiment of a watering device having a spring-loaded valve with a water outlet in an open state; and

FIG. 9 shows an embodiment of a watering device having a spring-loaded valve with a water outlet in a closed state.

### DETAILED DESCRIPTION OF THE INVENTION

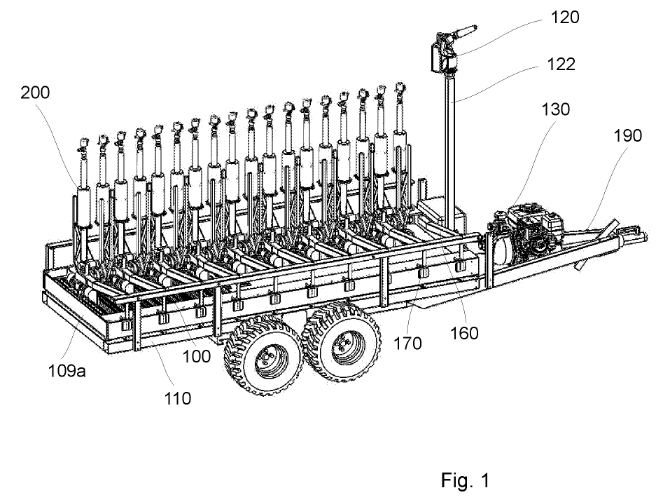

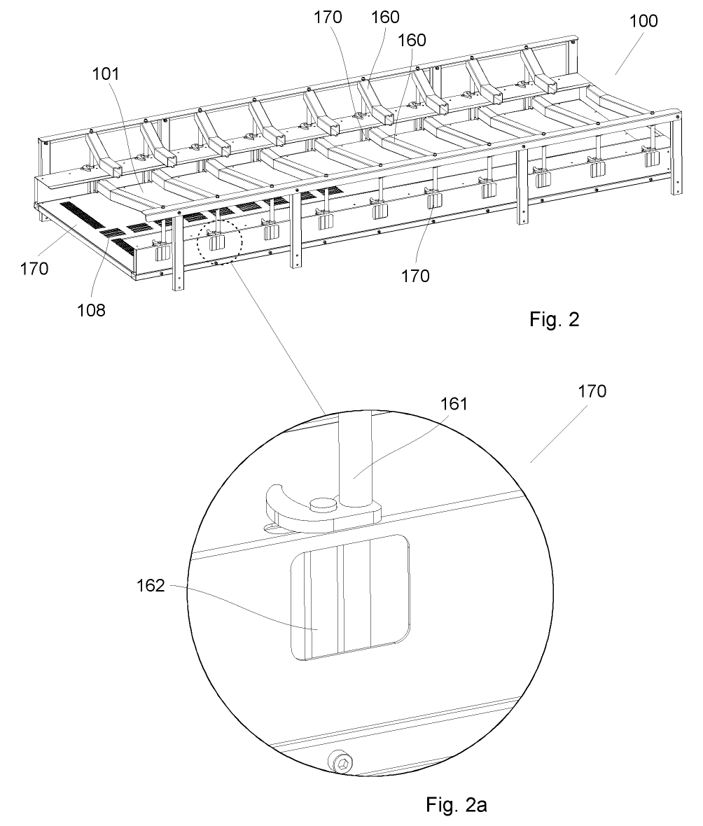

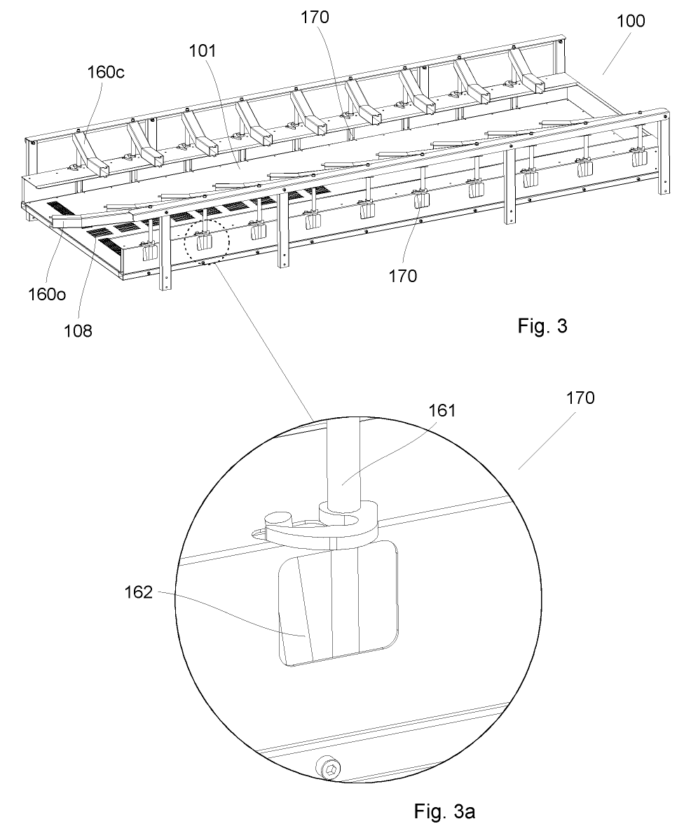

As aspect of the invention concerns a watering unit and a watering system. FIG. 1 illustrates the watering system installed on a trailer and FIGS. 2, 2a, 3, and 3a illustrate details of the watering unit.

A watering unit comprises a frame that is preferably a rigid metal frame but also other materials can be used. The frame typically has a width of about one to two metres and length of three to ten metres or even more than that. The frame is preferably configured to be mounted on a trailer or on a cargo bed of a vehicle. The watering unit is preferably a movable unit that can be loaded on to a vehicle or towed with a vehicle, such as an all-terrain vehicle, a truck, a tractor or some other suitable vehicle.

The frame has a hose compartment 100 that is preferably open at the top but limited with vertical walls on at least its long sides. The hose compartment has an opening 109 through which hoses and watering devices can be unloaded from the device. The opening can be realized by having one of the short sides 109a of the hose compartment open or removable so that it can be opened at will. The floor 101 of the hose compartment has a drain 108 on it to allow for water to flow through the floor. In the simplest form, the drain is just an orifice or a set of orifices, such as a perforated plate. The floor can also comprise grating instead of or in addition to any perforation to drain water. The drain can also be a pipe or a pipe fitting extending through the floor of the hose compartment.

The frame also comprises a water container 110 beneath the hose compartment 100. The water container, being located below the hose compartment, collects water from the hose compartment through the drain on the floor of the hose compartment. In an embodiment, the water is collected in the hose compartment 100 into a pipe or a pipe system which is drained into the water container 110 via a pipe or a pipe fitting extending through the floor of the hose compartment. The water container is either solely or at least mainly designed to be filled via the hose compartment. The water container may have a capacity of just 100 to 500 litres, preferably 200 to 300 litres. The water container is intended to be constantly filled when the watering unit is in use so a capacity larger than that is rarely, if ever, needed. The water container preferably has a drain valve for emptying the water container rapidly if needed.

The watering unit further comprises a water-spraying device 120 and a water pump 130 in fluid connection with the water container for pumping water from the water container 110 to the water-spraying device. The water-spraying device can be mounted on a pole 122 to the highest point of the watering unit so that it can be used to spray water to any direction. The water-spraying device is preferably a controllable directional water-spray device. Even more preferably, the operation of the water-spraying device can be controlled remotely.

The watering unit further comprises a plurality of arms 160 movable from a closed position 160c to an open position 160o. The arms can be fixed to the frame, such as to the sides of the hose compartment 100, preferably the long sides of the hose compartment, or to the floor 101 of the hose compartment, or to any other suitable part of the frame or the watering unit. The arms are movable by a turning or sliding motion and preferably the arms are fixed to the frame by a pivot pin 161 or by a hinge which allows the arm to turn or rotate about the pivot pin or the hinge. The pivot pin can be, for example, a pin or a bar either penetrating through one or more apertures on the arm or being welded or otherwise attached to the arm. In a preferred embodiment, the arms extend substantially perpendicularly to the long sides of the hose compartment in the closed position of the arm, whereas the open position of the arm is non-perpendicular to the long sides of the long sides of the hose compartment.

Each of the arms is configured to hold a watering device 200 in place in the closed position 160c and to release the watering device in the open position 160o. The holding of the watering device in place can be realized with a latch closing in the closed position and opening in the open position. Alternatively, the holding of the watering device can be based on a shape of the arm and/or the shape of the watering device which prevents the watering device from being released from the arm against forces in certain directions. For example, the arm can be designed to hold the watering device against forces applied on all other directions except a length direction of the arm.

Furthermore, each of the arms 160 has a hose clamp 170 connected thereto. The hose clamps are configured to move from a closed position to an open position by movement of the arm from the closed position of the arm to the open position of the arm. In other words, the hose clamp opens when the arm moves into its open position. The hose clamp can be realized by two pins or bars clamping the hose therebetween. Such a hose clamp could have the pivot pin 161 of the arm as one of its pins and the other pin 162 being eccentrically connected to the arm such that in the closed position of the arm the other pin is close to the pivot pin and in the open position of the arm the other pin is further away from the pivot pin. In another embodiment, the hose clamp could have the pivot of the arm as one of its pins and the other pin being eccentrically connected to the arm such that in the closed position of the arm the pins are parallel and close to each other and in the open position of the arm the other pin is tilted away from the pivot pin. Similar arrangements can be used with a hinged arm or with a sliding arm.

Each of the hose clamps 170 is preferably configured to restrict water flow in a hose 150 and hold the hose in place when the hose clamp is in its closed position, and to release the hose from the hose clamp when the hose clamp is moved into its open position. In case of the hose clamp having two clamping pins, a hose can be inserted into an open hose clamp by folding the hose into a flat loop and pushing the end of the loop between the pins while the hose clamp is open and then closing the hose clamp. The hose clamp now prevents completely or at least substantially restricts water flow in the hose and a fold formed at the end of the loop prevents the hose from sliding out from between the pins of the closed hose clamp. If the fold is not enough by itself to prevent the hose from sliding out, a piece of rope can be inserted in the loop to make the fold thicker. The hose is thus preferably clamped by a fold or a loop of the hose such that neither end of the hose goes through the hose clamp. This way, a hose can be easily released completely from the hose clamp without a risk of the hose tangling with the hose clamp.

Having now described the basics of the watering unit, next a watering system is described in detail. The watering system includes the watering unit of any embodiment presented within the present disclosure. In addition to the watering unit, the watering system comprises a plurality of watering devices, each having a supply line inlet 11, a supply line outlet 12. The watering system also comprises a plurality of hoses connected to said plurality of watering devices. Each hose of the plurality of hoses is connected to the supply line inlet 11 of a watering device and to the supply line outlet 12 of another watering device. Thus, the hoses and the watering devices form a chain of watering devices connected to one another with hoses, thereby providing a channel for water to flow from end to end of the chain. The watering devices can be sprinklers, sprayers, misters, or any other devices suitable for watering their immediate surroundings when water is supplied to the supply line inlet of the watering device.

A very simple example of a watering device is a perforated tube with hose connectors at both of its ends. When connected to a pressurized water source, water will spray through the perforations watering its immediate surroundings. A slightly more advanced version of this would have a three-way valve connected to the supply line inlet 11 at an end of the perforated pipe. Second one of the branches of the three-way valve is an open water outlet allowing water to flow out of the system and the third branch is connected to a pressurized water source. Now the three-way valve controls whether the water will flow out of the system via the open water outlet or into the supply line inlet 11, some water through the perforated tube spraying the water and the remaining flow being directed to the supply line outlet 12 to the next hose and towards the next watering device.

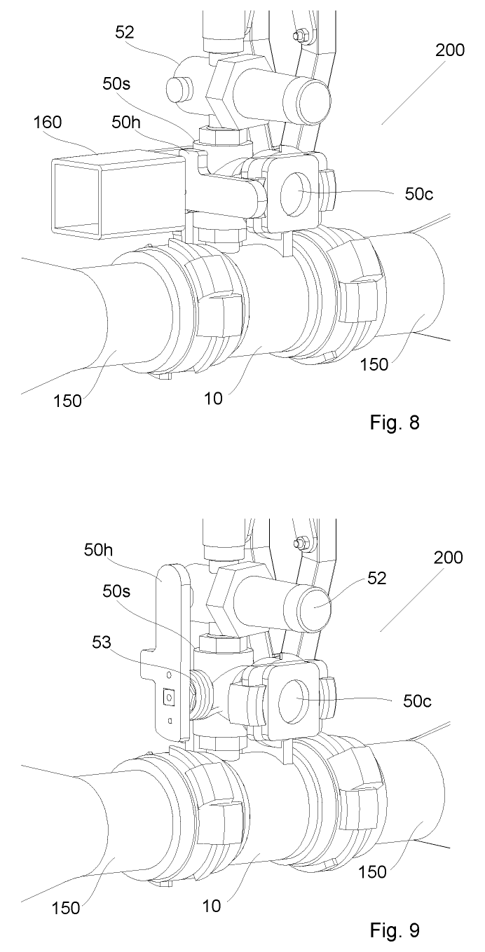

In an embodiment of the watering system, each watering device of the plurality of watering devices comprises a water outlet 50c in fluid communication with the supply line inlet 11. The water outlet is controlled with a spring-loaded valve 50s, such that the spring-loaded valve is configured to be in an open state allowing water to flow through the water outlet when the watering device is held by the arm, and the spring-loaded valve is configured to close when the watering device is released from the arm. In the above example of a perforated tube and a three-way valve, this embodiment would have a spring bias to move the three-way valve to a state where water flows to the supply line inlet 11 and to the perforated tube. When a lever 50h of the three-way valve is turned and held against the spring bias to the opposite position (as shown in FIG. 8), water would flow out via the water outlet until the lever is released and the spring bias returns the lever (as shown in FIG. 9). The spring-loaded valve can be kept in the open state by having an obstruction in the arm, which obstruction prevents the spring 53 from turning the lever 50h and switching the valve as long as the watering device is held by the arm. When the arm is moved into its open position, the watering device is released from the arm and obstruction of the arm no longer acts on the valve, so the spring-loaded valve closes the water outlet.

In an embodiment of the watering system, each watering device of the plurality of watering devices comprises a water outlet 50c in fluid communication with the supply line inlet 11. The water outlet is connected to a pipe system within the arms. The water outlet may be equipped with a valve that closes when the watering device is released from the arm. When water flows to the watering device connected to an arm, the water outlet 50c feeds water into the pipe system which drains the water to the water container 110.

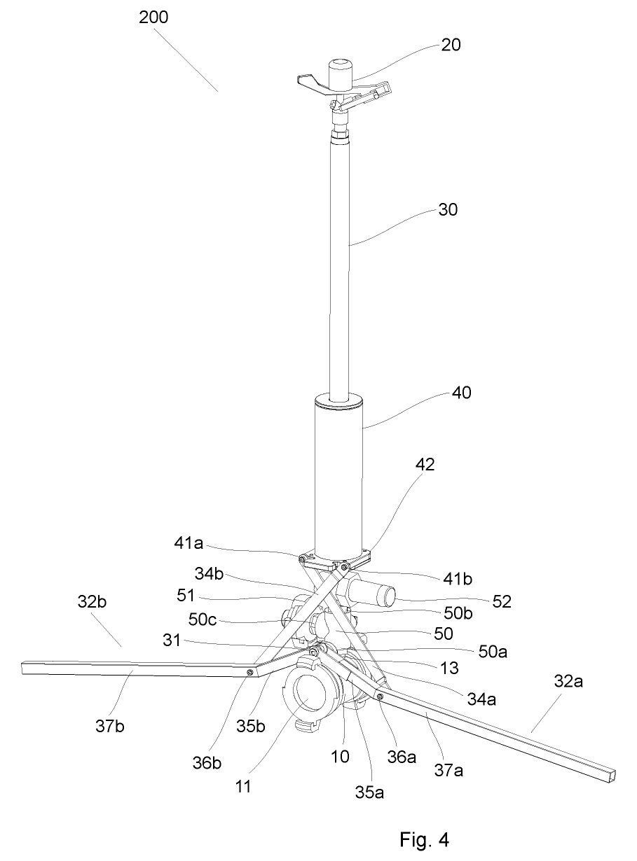

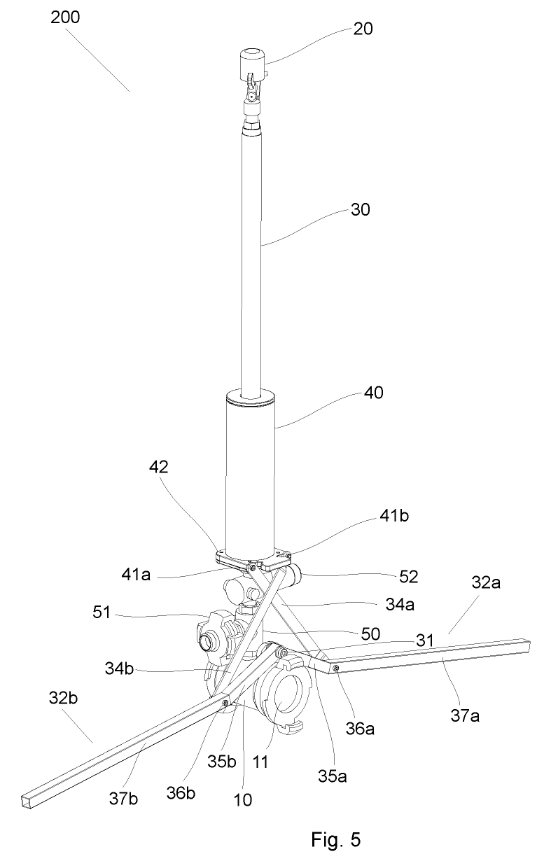

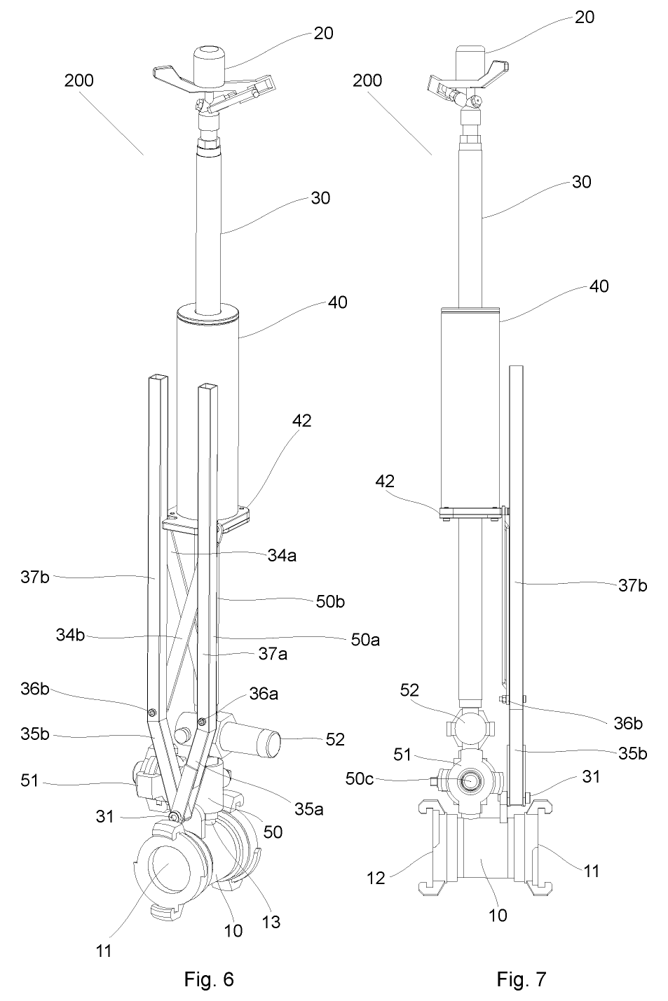

In an embodiment, the watering device is a self-erecting watering device. Such a device can be used, for example, in controlling wildfires and ground fires by using a plurality of such devices with a small enough spacing to water an elongated, continuous area of ground which the fires cannot spread over. Embodiments of the self-erecting watering device have been illustrated in FIGS. 4 to 9.

The self-erecting watering device comprises a pipe fitting 10 having a supply line inlet 11, a supply line outlet 12 and a distributor outlet 13, and a water distributor 20 for spraying or misting water. There is a conduit between the distributor outlet 13 of the pipe fitting 10 and the water distributor 20 for conveying water from the pipe fitting 10 to the water distributor 20. The self-erecting watering device has two or more support legs 32a, 32b movable between a closed position and an open position, and an actuator 40 attached to the two or more support legs 32a, 32b for moving said two or more support legs 32a, 32b from the closed position to the open position. The conduit comprises a three-way valve 50 having an inlet 50a in fluid communication with the distributor outlet 13 of the pipe fitting 10, a first outlet 50b in fluid communication with the water distributor 20, and a water outlet 50c for releasing water into the hose compartment 100 which then flows into the water container 110. The three-way valve 50 is preferably a spring-loaded valve 50s, wherein the spring-loaded valve is configured to be in an open state allowing water to flow through the water outlet when the watering device is held by the arm, and the spring-loaded valve is configured to close when the watering device is released from the arm. The actuator 40 of the self-erecting watering device is preferably a hydraulic actuator in fluid communication with the conduit, and configured to convert hydraulic pressure within said conduit to a linear motion.

As an example, the self-erecting watering device is described in more detail but many of the teachings can be applied to other types of watering devices as well and the invention is not limited to the embodiments including the self-erecting watering device. The self-erecting watering device comprises a pipe fitting 10 that is preferably arranged to be one of the lowermost parts of the device in an erect position of the device. The pipe fitting has at least a supply line inlet 11, a supply line outlet 12 and a distributor outlet 13. Water is supplied to the device using a water hose connected to the supply line inlet 11 and another water hose is connected to the supply line outlet 12 for supplying water for subsequent device, which then supplies water for the subsequent device, and so on. The first device of the line must of course be connected to a pressurized water source by a water hose. The pipe fitting 10 is preferably equipped with hose couplings on the supply line inlet and the supply line outlet. The couplings are preferably compatible with fire hoses commonly used in the area where the devices are being used on. For example, in many areas of Europe, claw couplings are commonly used, whereas National Hose/National Standard Thread (NH/NST) couplings are commonly used in North America. Preferably the supply line inlet and the supply line outlet are opposite to each other in the pipe fitting and they both have the same size or diameter. The distributor outlet 13 is used for distributing water with the device. The distributor outlet is preferably facing in a direction perpendicular to the supply line inlet and the supply line outlet. Preferably the distributor outlet faces upwards when the device is in the erect position. The distributor outlet is preferably smaller in size or diameter than the supply line inlet and the supply line outlet as only a small fraction of the supplied water stream is intended to be distributed via a single watering device.

The watering device also comprises a water distributor 20 for spraying or misting water. The water distributor preferably sprays water in the form of relatively large droplets while simultaneously producing fine droplets forming mist into the surrounding air. The water distributor can also be a single mode sprinkler device mostly distributing water in relatively large droplets or a single mode misting device mostly distributing water in relatively small droplets. In an embodiment, the water distributor is a dual mode spray/mist sprinkler which can be configured to distribute the water in either large droplets or small droplets. The device has a conduit between the distributor outlet 13 of the pipe fitting 10 and the water distributor 20 for conveying water from the pipe fitting 10 to the water distributor 20. The conduit can be formed by a single part, such as a pipe, or by multiple parts, such as pipes, pipe fittings, regulators, etc attached to one another in a way that allows water to flow through the conduit. In an embodiment, the device comprises a rigid tube 30 between the distributor outlet 13 of the pipe fitting and the water distributor 20, thereby the rigid tube defines at least part of the conduit. The water distributor 20 is preferably the part of the device that is furthest from the ground when the device is in its erect position on the ground.

The self-erecting watering device further comprises two or more support legs 32a, 32b. In a preferred embodiment there are two support legs as shown in FIGS. 4 to 7 but also three support legs or four support legs can be used. The support legs are movable at least between a closed position and an open position and preferably also between the open position and the closed position. The device is preferably configured to move into the erect position as a consequence of the support legs moving from the closed position to the open position. However, the device may not have any predetermined or predictable position when the support legs are in the closed position. Preferably, the two or more support legs in the closed position are parallel or at least substantially parallel to the conduit, or parallel to a direction passing the end points of the conduit if the conduit does not follow a straight line.

In a preferred embodiment, the two or more support legs 32a, 32b in the open position are perpendicular or at least substantially perpendicular to a line defined by the centre points of the supply line inlet 11 and the supply line outlet 12 of the pipe fitting 10. This embodiment is particularly useful as the device can be positioned in all three orthogonal directions (X-Y-Z) with the afore-mentioned setup. The pipe fitting 10 having water supply hoses connected to the supply line inlet and the supply line outlet define two of the three axes. Firstly, the water hoses filled with water under pressure are relatively heavy but also substantially rigid as the water pressure forces the water hoses to essentially follow a straight line. The water hoses lie against the ground in an essentially straight line which also forces the supply line inlet and the supply line outlet to align with that straight line. We shall call the direction of water hoses X-axis. The weight of the water in the water hoses combined with the rigidity of the pressurized water hoses and gravity pulls the pipe fitting 10 downwards, i.e. towards the ground. The direction of this force is perpendicular to the X-axis, and we shall call it Y-axis. The Z-axis is stabilized by the support legs in their open position. The support legs in the open position being perpendicular to the line defined by the centre points of the supply line inlet and the supply line outlet means that the support legs are perpendicular to the X-axis defined earlier. Distant ends of the support legs are preferably the lowermost part of the device, extending slightly lower than the pipe fitting. This means, at least on a substantially even ground, that the distant ends of the support legs are in contact with the ground in their open position. Preferably, the pipe fitting is raised just above the ground by the support legs 32a, 32b moving from their closed position to their open position. Especially when the pipe fitting 10 is one of the lowermost parts of the device when the support legs are in the open position, the force of gravity forces the device to the erect position because of the relatively heavy weight of the pipe fitting and the water hoses attached to it, compared to the rest of the device. Thus, the device is self-erecting. The situation described here does not change meaningfully if the support legs are not perfectly perpendicular, but merely substantially perpendicular, to the line defined by the centre points of the supply line inlet and the supply line outlet of the pipe fitting. If the angle is, for example 80 degrees, the component in the perpendicular direction is still almost the same as in the perfectly perpendicular case of the 90-degree angle.

The device further comprises an actuator 40 attached to the two or more support legs 32a, 32b for moving the two or more support legs from the closed position to the open position. The actuator is crucial for the self-erecting feature as it ensures that no human interaction is needed directly with the device in order to move the device into its erect position. The actuator can be a passive actuator, such as a tensioned spring, or an active actuator, such as an electric actuator, pneumatic actuator or hydraulic actuator. When a tensioned spring is used as the actuator, the spring has to be manually pre-tensioned before intended use, for example during assembly or preparation of the device. When an electric actuator is used, the device may comprise a battery or a similar energy source to power the electric actuator. When a pneumatic actuator is used, the device may comprise a pressure vessel containing compressed air or a similar energy source to power the pneumatic actuator.

In a preferred embodiment, the actuator 40 is a linear actuator because the movement of the support legs between the closed position and the open position is linear. The actuator can also be a non-linear actuator, such as a rotary actuator and the device further comprises means for transforming a rotary motion of the actuator into a linear motion of the support legs. The support legs may also be designed in such a way that the type of movement between the closed position and the open position of the support legs is rotary motion. An example of a passive linear actuator is a tensioned coil spring. Examples of active linear actuators are electric linear actuators, pneumatic linear actuators and hydraulic linear actuators. Any actuator type can be set to be activated automatically in the presence of water or pressure, for example, in the conduit of the device. The actuator could also be activated manually by, for example, removing a cotter pin when the device is deployed on the ground.

The type of actuator used in the device is preferably a hydraulic actuator and more preferably a hydraulic linear actuator. The hydraulic actuator is preferably in fluid communication with the conduit of the device, and configured to convert hydraulic pressure within said conduit to a linear motion. A benefit of this embodiment is that the hydraulic pressure of the water supplied to the device can be utilized to power the actuator and other external energy sources are not needed. Compared to the passive linear actuator, such as a tensioned coil spring, the hydraulic actuator requires no preparation and does not lose its functionality during a prolonged storage time. Preferably the hydraulic actuator is a hydraulic cylinder that uses pressurized fluid, i.e. water in this case, to generate force and motion. Hydraulic actuators are preferred because they are capable of producing relatively high forces and are very reliable and durable.

In an embodiment, the actuator 40 comprises a first part and a second part movable in relation to the first part. The first part of the actuator is fixed to the rigid tube and the second part is pivotably attached to the two or more support legs 32a, 32b. The actuator in this case is preferably a hydraulic linear actuator such as a hydraulic cylinder. The first part can be a piston of the hydraulic cylinder or the cylinder. In an embodiment, the device comprises a rigid tube 30 that defines at least part of the conduit but also functions as part of the piston of the hydraulic cylinder. When pressurized water flows into the cylinder of the hydraulic cylinder type actuator, the cylinder and the piston move relative to each other. Now if the piston is fixed to the device, the cylinder moves in relation to the first part of the actuator. This type of embodiment is illustrated in FIGS. 4 to 7 as one practical example of the device. The second part, that is the movable part, of the actuator preferably has one or two or more pivot points 41a, 41b for pivotally attaching the two or more support legs to the second part of the actuator. The pivot points can be arranged to the second part of the actuator by having a plate 42 fixed to the second part where the plate has through holes or some other forms that can be used as the pivot points. The pivot points can also be arranged directly on the second part of the actuator.

The self-erecting watering device can further comprise two or more guide bars 34a, 34b that can be used for pivotally attaching the support legs 32a, 32b to the second part of the actuator. Each of the two or more support legs can be pivotably attached to a first end of a guide bar, where a second end of the guide bar, opposite to the first end of the guide bar, can be pivotably attached to a movable part of the actuator. In an embodiment, the second ends of the guide bars can be pivotably attached to the pivot points 41a, 41b of the plate 42, that is fixed to the second part of the actuator as shown in FIGS. 4 to 7. The guide bars 34a, 34b can pivot both in relation to the support legs and in relation to the second part of the actuator.

Depending on the design of the actuator and the support legs, a very high force may be required in the beginning of the moving the support legs from the closed position to the open position. The force required in the motion can be reduced by having a curve or a bend in the support legs. In a preferred embodiment, each of the support legs 32a, 32b comprises two or more mutually non-parallel straight sections 35a, 37a; 35b, 37b. Each of the support legs has a pivot point 36a, 36b for a guide bar at the area where the two non-parallel straight sections connect to each other. The first end of the guide bar can be pivotably attached to said pivot point 36a, 36b thereby reducing the force required in the beginning of the motion of the support legs. The initial force can be further reduced by pivotably attaching the first ends of the guide bars to the pivot points 36a, 36b of the support legs and having the guide bars cross one another between the first end and the second end of the guide bars. That is, in the embodiment of FIG. 4 for example, the first end of one guide bar 34a is pivotably attached to the support leg 32a on the right-hand side of the device and the second end of the same guide bar 34a is attached to the pivot point 41a on the left-hand side of the device, whereas the other guide bar 34b is attached to the support leg 32b on the left-hand side and to the pivot point 41b on the right-hand side.

In an embodiment, the device comprises two support legs that are pivotably attached to a common pivot point 31 on the device. This is preferably in addition to the pivotable attachment between the support legs and the second part of the actuator. Preferably the two support legs are attached from one of their ends, pivoted ends, to the common pivot point, whereas the opposite ends of the support legs are the distal ends of the support legs that are arranged to be in contact with ground when the support legs are in their open position. In this case, a leverage coefficient is defined the ratio between the distance from the pivoted end of a support leg to the pivot point 36a, 36b of the support leg and the distance from the distal end of the support leg to the pivot point 36a, 36b of the support leg. Preferably, the ratio is smaller than 1, meaning that the pivot point 36a, 36b of the support legs is closer to the pivoted end of the support legs than the distal end of the support legs. The ratio being smaller than 1 means that when the second part of the actuator 40 is moved by a certain distance, the distal ends of the support legs move a greater distance. The common pivot point 31 is preferably fixed onto the pipe fitting 10 of the device, but the common pivot point can also be fixed or pivotable attached to some other place on the device. The design and placement of the support legs and possible guide bars and their pivot points dictate suitable locations for the common pivot point.

There is often a need to set up a long chain of the self-erecting watering devices described herein in order to prevent a wildfire or a groundfire from spreading into an unwanted area or direction. A water source providing water for the devices has a certain water pressure which is essentially the water pressure at the supply line inlet of the first device in the chain. As part of water stream entering the device is sprayed and/or misted with the water distributor, the water pressure at the supply line inlet of the second device is smaller. This also means that an effective watering radius of the first device of the chain would be the largest and it would diminish along the chain of devices. To alleviate said drawback, preferably the conduit between the pipe fitting 10 and the water distributor 20 comprises a pressure reducing valve 52 for reducing pressure of water conveyed through the conduit to the water distributor 20. The pressure reducing valve reduces the water pressure to a constant level that is optimal for the water distributor. The pressure reducing valve could be set to, for example, 400 kPa or 500 kPa or to some value in a range from 200 kPa to 800 kPa. This would have the effect of the devices in chain having similar effective watering range up to a point in the chain where the water pressure falls below the pressure set on the pressure reducing valves. The water pressure would also remain higher for further down the chain as the first devices would consume considerably less water than without the pressure reducing valves.

There may also rise a need to use water directly from the watering unit. This can be realized with the conduit of the device comprising a three-way valve 50 having an inlet 50a in fluid communication with the distributor outlet 13 of the pipe fitting 10, a first outlet 50b in fluid communication with the water distributor 20, and a water outlet 50c for releasing water into the hose compartment which then flows into the water container. The water may be released on the floor of the hose compartment and then drained to the water container, especially when it is beneficial to wet the hoses before releasing them from the hose compartment. The water may also be released into a pipe or a pipe system of the hose compartment and the drained into the water container via a pipe or a pipe fitting extending through the floor of the hose compartment. The water outlet may have a hose connector 51 for attaching a hose thereto. Preferably, the hose connector 51 used in the water outlet 50c of the three-way valve is of the same type as the hose connector used in the supply line outlet 12. The three-way valve 50 is preferably located before a pressure reducing valve, if any, in order to provide the maximum water pressure available at the device. With the device having the three-way valve, water can be distributed locally to whatever purpose without breaking the chain of devices by simply diverting the water flow to the hose connector 51 instead of the water distributor 20, or in addition to.

In a preferred embodiment, the self-erecting watering device comprises, in a flow direction of water from the pipe fitting 10 to the water distributor 20, the pipe fitting 10 connected to a three-way valve 50, the three-way valve 50 connected to a pressure reducing valve 52, the pressure reducing valve 52 being also connected to a rigid tube 30, a hydraulic actuator 40 in a fluid communication with the rigid tube 30, and the rigid tube 30 being also connected to a water distributor 20. This set of parts in this order has been found to result the best combination of features for most purposes while still being simple enough for reliable operation.

An aspect of the invention is a watering method using the watering unit and the watering system described in the present disclosure. One of typical use cases is to connect the watering system to a pressurized water source with a hose and then use a vehicle to transport the watering unit on a terrain that needs to be watered. The weight of the connecting hose pulls the arms 160 holding the watering units from the closed position 160c to open position 160o one by one as the vehicle drives forward with the watering unit. Once an arm moves to an open position, it releases the watering device 200 it was holding and opens a hose clamp 170 connected to the arm in questions. As the vehicle continues to drive forward, the released watering device drops on the ground and begins to pull the hose 150 that was just released from the hose clamp. At the same time, the pressurized water enters the hose past the hose clamp and into the next watering unit in the chain. This process repeats when the hose is laid straight on the ground and pulls the next arm into open position. With a watering system of , for example, 25 arms, each having a watering device and 20 metres of hose between each watering device, about 500 metres of watering line can be built in just a few minutes. The watering line can even be extended with another similar watering system connected to last watering device of the first watering system. The benefit is that the water container of the watering unit can be practically constantly filled with the water outlet of the next watering device to be released as that is always connected to the pressurized water source. It is also worth noting that only a small section of hose still within the watering unit is pressurized and filled with water at any given time. The hose clamps prevent all but one of the hoses from pressurizing while they are still within the watering unit. This allows for more hose to be loaded and much less water weight to be transported.

The watering method comprises a step of acquiring the watering system of the present disclosure and a step of preparing the watering unit. The preparing is done by placing the plurality of watering devices 200 onto the plurality of arms 160, inserting a single hose 150 to each of the hose clamps 170 of the arms holding a watering device, and moving said arms to a closed position 160c thereby clamping the hoses in the hose clamps. Depending on the situation, there can be arms without a watering device, i.e. arms that are not used, and typically the hose clamp of such an arm is not used either. For any given arm holding a watering device, the hose connected to the supply line outlet of that watering device is preferably clamped with the hose clamp of that arm close to the end that is connected to the supply line outlet. This prevents the hose from being filled with water and thus helps to keep the hose untangled and weight of the watering unit manageable. After the hose clamp, the remaining hose is of folded into the hose compartment so that it can be released smoothly. The other end of the hose is connected to the supply line inlet of the next watering device held by the next arm in line, and this repeats until there are no more arms or watering devices. The supply line outlet of the last watering device in line can be plugged to prevent pressure inside the line from dropping after the second last watering device has been released.

The method further comprises a step of connecting a pressurized water source with a hose to the supply line inlet 11 of the watering device closest to the opening of the hose compartment. The watering device closest to the opening 109 of the hose compartment 100 is released first to prevent the hoses from tangling to one another. The pressurized water source is not part of the watering system as it can be virtually any suitable and available water source, such as a fire hydrant, a water pump or any suitable mains water outlet.

The method also comprises a step of transporting the watering unit on a terrain, and a step of moving the plurality of arms holding the plurality of watering devices from the closed position 160c to the open position 160o one by one. The moving of arms starts from the arm closest to the opening of the hose compartment, thereby each time releasing a watering device and opening a hose clamp to pressurize the subsequent hose and the next watering device to be released. Preferably the moving of the plurality of arms to open position one by one is performed by moving the watering unit and allowing the weight of the hose connected to the supply line inlet 11 of the next watering device to be released to pull the arm holding the next watering device to be released to the open position.

In an embodiment, each watering device of the plurality of watering devices comprises a water outlet in fluid communication with the supply line inlet 11. The water outlet is controlled with a spring-loaded valve 50s, wherein the spring-loaded valve is configured to be in an open state allowing water to flow through the water outlet when the watering device is held by the arm, and the spring-loaded valve is configured to close when the watering device is released from the arm. In this embodiment the method further comprises a step of watering the hose compartment via the water outlet of the next watering device to be released. This water the flows through the drain 108 in the floor 101 of the hose compartment 100 and into the water container 110 of the watering unit. The watering of the hose compartment can be realized by releasing water into a pipe or a pipe system of the hose compartment, from which the water is then drained into the water container. The water can then be used from the water container which is preferably continuously refilled this way. This allows for continuous use of the water-spraying device 120 far from nearest pressurized water source without having to transport a huge container of water there. In an embodiment, the method thus comprises a step of operating the water-spraying device and the water pump 130 to spray water from the water container.

In an embodiment of the watering method, the watering unit is transported by towing it on trailer 190 or by driving a vehicle having the watering unit onboard. The watering unit is preferably a module so that an empty watering unit without any watering devices can be quickly swapped to a watering unit that has already been prepared.

As technology evolves, a person skilled in the art acknowledges that the basic principle of the invention can be realized in various ways. The invention and its embodiments are not limited to the examples above but can vary within the scope of the claims.

1. A watering unit comprising a frame having a hose compartment and a water container beneath the hose compartment, where the hose compartment has a drain on its floor and an opening for a hose, wherein the water container is located below the hose compartment and configured to collect water through the drain on the floor of the hose compartment, wherein the watering unit further comprises a water-spraying device and a water pump in fluid connection with the water container for pumping water from the water container to the water-spraying device, wherein the watering unit further comprises a plurality of arms movable from a closed position to an open position, each of said arms being configured to hold a watering device in place in the closed position and to release the watering device in the open position, where each of the arms has a hose clamp connected thereto, where the hose clamps are configured to move from a closed position to an open position by movement of the arm from the closed position of the arm to the open position of the arm.

2. The watering unit of claim 1, where said plurality of arms is located above the hose compartment, where the arms are pivotably fixed to the frame thereby allowing the arms to turn about a pivot pin between the closed position and the open position.

3. The watering unit of claim 1, where each of the hose clamps is configured to restrict water flow in a hose and hold the hose in place when the hose clamp is in its closed position, and to release the hose from the hose clamp when the hose clamp is moved into its open position.

4. The watering unit of claim 1, where the frame is mounted on a trailer or on a cargo bed of a vehicle.

5. A watering system comprising the watering unit of claim 1, where the watering system further comprises
a plurality of watering devices, each having a supply line inlet, a supply line outlet,
a plurality of hoses connected to said plurality of watering devices, where each hose of the plurality of hoses is connected to the supply line inlet of a watering device and to the supply line outlet of another watering device.

6. The watering system of claim 5, where each watering device of the plurality of watering devices comprises a water outlet in fluid communication with the supply line inlet, which water outlet is controlled with a spring-loaded valve, wherein the spring-loaded valve is configured to be in an open state allowing water to flow through the water outlet when the watering device is held by the arm, and the spring-loaded valve is configured to close the water outlet when the watering device is released from the arm.

7. The watering system of claim 5, wherein the watering device is a self-erecting watering device comprising
a pipe fitting having a supply line inlet, a supply line outlet and a distributor outlet,
a water distributor for spraying or misting water,
a conduit between the distributor outlet of the pipe fitting and the water distributor for conveying water from the pipe fitting to the water distributor,
two or more support legs movable between a closed position and an open position, and
an actuator attached to the two or more support legs for moving said two or more support legs from the closed position to the open position,
wherein the conduit comprises a three-way valve having an inlet in fluid communication with the distributor outlet of the pipe fitting, a first outlet in fluid communication with the water distributor, and a water outlet.

8. The watering system of claim 7, wherein said actuator of the self-erecting watering device is a hydraulic actuator in fluid communication with said conduit, and configured to convert hydraulic pressure within said conduit to a linear motion.

9. A watering method comprising steps of
acquiring the watering system of claim 5,
preparing the watering unit by placing the plurality of watering devices onto the plurality of arms, inserting a single hose to each of the hose clamps of the arms holding a watering device, and moving said arms to a closed position thereby clamping the hoses in the hose clamps,
connecting a pressurized water source with a hose to the supply line inlet of the watering device closest to the opening of the hose compartment,
transporting the watering unit on a terrain, and
moving the plurality of arms holding the plurality of watering devices from the closed position to the open position one by one, starting from the arm closest to the opening of the hose compartment, thereby each time releasing a watering device and opening a hose clamp to pressurize the subsequent hose and the next watering device to be released.

10. The watering method of claim 9, wherein the moving of the plurality of arms to open position one by one is performed by moving the watering unit and allowing the weight of the hose connected to the supply line inlet of the next watering device to be released to pull the arm holding the next watering device to be released to the open position.

11. The watering method of claim 9, where each watering device of the plurality of watering devices comprises a water outlet in fluid communication with the supply line inlet, which water outlet is controlled with a spring-loaded valve, wherein the spring-loaded valve is configured to be in an open state allowing water to flow through the water outlet when the watering device is held by the arm, and the spring-loaded valve is configured to close when the watering device is released from the arm, and the method further comprises a step of watering the hose compartment via the water outlet of the next watering device to be released.

12. The watering method of claim 11, wherein the method further comprises a step of operating the water-spraying device and the water pump to spray water from the water container.

13. The watering method of claim 9, where the watering unit is transported by towing it on a trailer.
